(19) United States
(12) Patent Application Publication
(10) Pub. No.: US 2025/0392486 A1
(43) Pub. Date: Dec. 25, 2025

(54) TRANSACTION PROPOSAL METHODS AND CONSENSUS NODES IN BLOCKCHAIN SYSTEMS, AND BLOCKCHAIN SYSTEMS

(71) Applicant: Ant Blockchain Technology (Shanghai) Co., Ltd., Shanghai (CN)

(72) Inventor: Kang RONG, Hangzhou (CN)

(73) Assignee: Ant Blockchain Technology (Shanghai) Co., Ltd., Shanghai (CN)

(21) Appl. No.: 19/317,358

(22) Filed: Sep. 3, 2025

Related U.S. Application Data
(63) Continuation of application No. PCT/CN2023/135251, filed on Nov. 29, 2023.

(30) Foreign Application Priority Data
Apr. 3, 2023 (CN) 202310348362.9

(51) Int. Cl. H04L 9/00

(52) U.S. Cl. CPC H04L 9/50

(57) ABSTRACT

Described is blockchain system transaction proposal applied to any target consensus node that has blockchain system transaction proposal permission. The blockchain system includes a plurality of consensus nodes that have transaction proposal permission. Local transaction pools of the consensus nodes include duplicate transactions. A digest value of a transaction maintained in a local transaction pool is calculated. An arithmetic operation is performed on the digest value and a predetermined value. Based on an operation result of the arithmetic operation, determining whether the target consensus node has transaction proposal permission for the transaction. If the target consensus node has transaction proposal permission for the transaction, the transaction is added to a pending-consensus transaction set proposed by the target consensus node for a pending-consensus target block.

### CROSS-REFERENCE TO RELATED APPLICATIONS

This application is a continuation of PCT Application No. PCT/CN2023/135251, filed on Nov. 29, 2023, which claims priority to Chinese Patent Application No. 202310348362.9, filed on Apr. 3, 2023, and each application is hereby incorporated by reference in its entirety.

### TECHNICAL FIELD

One or more embodiments of this application relate to the field of blockchain technologies, and in particular, to transaction proposal methods and consensus nodes in blockchain systems, and blockchain systems.

### BACKGROUND

Blockchain is a novel application mode of distributed data storage, peer-to-peer transmission, consensus protocol, encryption algorithm, and other computer technologies. In a blockchain system, data blocks are organized into a chain data structure in chronological order, and distributed ledgers that cannot be tampered with or forged are cryptographically ensured. The blockchain has characteristics such as decentralization, tamper-resistance of information, and autonomy, and therefore the blockchain is more widely applied.

### SUMMARY

One or more embodiments of this application provide transaction proposal methods, consensus nodes, and blockchain systems in asynchronous consensus process, and include a transaction proposal method in a blockchain system, where the blockchain system includes a plurality of consensus nodes that have transaction proposal permission; local transaction pools of the consensus nodes that have transaction proposal permission in the blockchain system include duplicate transactions; and the method is applied to any target consensus node that has transaction proposal permission in the blockchain system, and includes: calculating a digest value of a transaction maintained in a local transaction pool; performing an arithmetic operation on the digest value and a predetermined value; and determining, based on an operation result of the arithmetic operation, whether the target consensus node has transaction proposal permission for the transaction; and if the target consensus node has transaction proposal permission for the transaction, adding the transaction to a pending-consensus transaction set proposed by the target consensus node for a pending-consensus target block.

A consensus node in a blockchain system is provided. The blockchain system includes a plurality of consensus nodes that have transaction proposal permission; local transaction pools of the consensus nodes that have transaction proposal permission in the blockchain system include duplicate transactions; and the consensus node has transaction proposal permission; and the system includes: a digest value calculation unit, configured to calculate a digest value of a transaction maintained in a local transaction pool; an arithmetic operation unit, configured to perform an arithmetic operation on the digest value and a predetermined value; and a transaction allocation unit, configured to determine, based on an operation result of the arithmetic operation, whether a target consensus node has transaction proposal permission for the transaction; and if the target consensus node has transaction proposal permission for the transaction, add the transaction to a pending-consensus transaction set proposed by the target consensus node for a pending-consensus target block.

A blockchain system is provided, including a consensus node. The blockchain system includes a plurality of consensus nodes that have transaction proposal permission; local transaction pools of the consensus nodes that have transaction proposal permission in the blockchain system include duplicate transactions; and any target consensus node that has transaction proposal permission in the blockchain system is configured to: calculate a digest value of a transaction maintained in a local transaction pool; perform an arithmetic operation on the digest value and a predetermined value; and determine, based on an operation result of the arithmetic operation, whether the target consensus node has transaction proposal permission for the transaction; and if the target consensus node has transaction proposal permission for the transaction, add the transaction to a pending-consensus transaction set proposed by the target consensus node for a pending-consensus target block.

In the above-mentioned embodiments, the target consensus node in the blockchain system can calculate the digest value of the transaction maintained in the local transaction pool, and perform an arithmetic operation on the digest value and the predetermined value, to match the operation result of the arithmetic operation against the node identifier of the target consensus node, and determine, based on a matching result, whether to add the transaction in the pending-consensus transaction set proposed by the target consensus node for the pending-consensus target block.

By adopting the above approach, for any consensus node with transaction proposal authority in the blockchain system, it is no longer necessary to randomly select several transactions from its local transaction pool for proposal. Instead, for any transaction maintained in its local transaction pool, the consensus node can determine whether to add the transaction to the pending-consensus transaction set proposed by the node for the pending-consensus target block. Thus, this is effectively equivalent to selecting a suitable consensus node from among multiple consensus nodes that maintain the same transaction in their local transaction pools, and having that consensus node propose the transaction for the pending-consensus target block. This avoids multiple consensus nodes selecting and proposing the same transaction from their respective local transaction pools, thereby reducing the probability of different consensus nodes proposing the same transaction. As a result, the transaction duplication rate during the consensus process can be lowered, resource waste during consensus can be reduced, and duplication of transactions in the final agreed block can be avoided, thus solving the problem of the same transaction being executed multiple times.

### BRIEF DESCRIPTION OF DRAWINGS

To illustrate the technical solutions of embodiments of this specification more clearly, the following briefly describes the accompanying drawing for describing the embodiments. Clearly, the accompanying drawings in the following description merely show some embodiments recorded in this application, and those of ordinary skill in the art can obtain other drawings from these accompanying drawings without any creative efforts.

FIG. 1 is a schematic diagram illustrating a blockchain system, according to one or more example embodiments of this application;

FIG. 2 is a schematic diagram illustrating a conventional phase in a PBFT protocol, according to one or more example embodiments of this application;

FIG. 3 is a schematic diagram illustrating a HoneyBadgerBFT protocol, according to one or more example embodiments of this application;

FIG. 4 is a flowchart illustrating a transaction proposal method in an asynchronous consensus process, according to one or more example embodiments of this application;

FIG. 5 is a schematic structural diagram illustrating a device, according to one or more example embodiments of this application; and

FIG. 6 is a schematic architectural diagram illustrating a consensus node in a blockchain system, according to one or more example embodiments of this application.

### DETAILED DESCRIPTION

To make a person skilled in the art better understand the technical solutions in this application, the following describes in detail the technical solutions in embodiments of this application with reference to the accompanying drawings in embodiments of this application. Clearly, the described embodiments are merely some but not all of embodiments of this application. All other embodiments obtained by a person of ordinary skill in the art based on embodiments of this application without creative efforts shall fall within the protection scope of this application.

Blockchains are usually classified into three types: public blockchains, private blockchains, and consortium blockchains. In addition, there are combinations of the above-mentioned plurality of types, such as a combination of the private blockchain and the consortium blockchain, and a combination of the consortium blockchain and the public blockchain.

A public blockchain has the highest degree of decentralization in the above-mentioned three types of blockchains. Participants that join the public blockchain (also be referred to as nodes in the blockchain) can read data records in the blockchain, participate in transactions, contend for ledger permission of a new block, etc. In addition, each participant can freely join and exit the network and perform related operations.

A private blockchain is an opposite of the public blockchain. Write permission of the network is controlled by a certain organization or institution, and data read permission is specified by the organization. In other words, the private blockchain can be considered as a weakly centralized system, and has few nodes with strict restrictions. This type of blockchain is more suitable for internal use of specific institutions.

A consortium blockchain lies between the public blockchain and the private blockchain, achieving “partial decentralization”. Each node in the consortium blockchain usually has a corresponding entity organization or institution. Nodes are authorized to join the network and form a stakeholder alliance, and jointly maintain the operation of the blockchain.

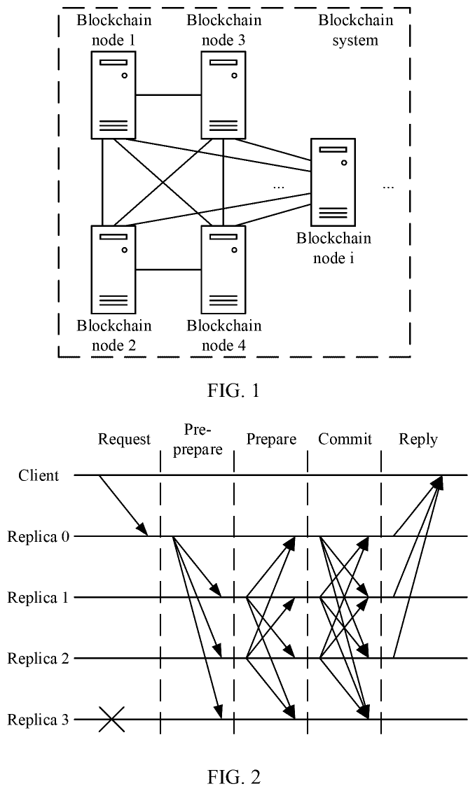

Referring to FIG. 1, FIG. 1 is a schematic diagram illustrating a blockchain system, according to one or more example embodiments of this application.

As shown in FIG. 1, the blockchain system can maintain one or more blockchains (for example, a public blockchain, a private blockchain, and a consortium blockchain), and can include a plurality of blockchain nodes used to host the above-mentioned one or more blockchains. For example, as shown in FIG. 1, a blockchain node 1, a blockchain node 2, a blockchain node 3, a blockchain node 4, a blockchain node i, etc., can jointly host the one or more blockchains. Cross-chain data access can be further performed between blockchains included in each blockchain system, and between blockchain systems.

The blockchain node is a logical communication entity. A plurality of blockchain nodes of different types can run on the same physical server or can run on different physical servers. In an illustrated implementation, the blockchain node can be a physical device or a virtual device implemented in a server or a server cluster. For example, the blockchain node can be a physical host in the server cluster or can be a virtual machine created after hardware resources piggybacked on the server or the server cluster are virtualized based on a virtualization technology. The blockchain nodes can be coupled together through various types of communication methods (for example, TCP/IP) to form a network to host one or more blockchains.

Based on basic characteristics of the blockchain, the blockchain usually includes several blocks. In each of these blocks, a timestamp that corresponds to a moment of creation of the block is recorded. All the blocks form a temporally ordered strip of data chain in strict accordance with the timestamps recorded in the blocks.

For data generated outside the blockchain, the data can be constructed int a standard transaction format supported by the blockchain, and then released to the blockchain, where nodes participating in consensus in the blockchain system perform consensus processing on the transaction and execute the transaction after the consensus processing is completed, so that the transaction and an execution result can be persistently deposited in the blockchain.

In the blockchain system, different participants can build a distributed blockchain network through deployed nodes. A decentralized (or referred to multicentralized) distributed ledger constructed by using a chained block structure is stored in all nodes (or the majority of nodes, for example, consensus nodes) in the distributed blockchain network. This type of blockchain system needs to achieve consistency and correctness of data in respective ledgers in a plurality of nodes that are decentralized (or multicentralized). Each node in the blockchain system runs a blockchain program, and under a design of specific fault tolerance needs, a consensus protocol is used to ensure that all loyal nodes have the same transactions, to ensure that all the loyal nodes achieve consistent execution results for the same transactions, and package the transactions and the execution results into blocks.

Current mainstream consensus protocols include a proof of work (PoW), a proof of stake (POS), a delegated proof of stake (DPOS), a practical Byzantine fault tolerance (PBFT) algorithm, a HoneyBadger Byzantine fault tolerance (HoneyBadgerBFT) algorithm, etc. These consensus protocols can usually be divided into two types: asynchronous consensus protocols and non-asynchronous consensus protocols. For example, the PBFT algorithm is a partial synchronous protocol, while the HoneyBadgerBFT algorithm is an asynchronous protocol.

The PBFT algorithm is used as an example. The algorithm was proposed by Miguel Castro and Barbara Liskov in 1999, resolves a problem of low efficiency of an original Byzantine fault tolerance algorithm, and reduces algorithm complexity from an exponential level to a polynomial level, making the Byzantine fault tolerance algorithm feasible in practical system applications. This paper was published at the 1999 Symposium on Operating Systems Design and Implementation (OSDI99). In the PBFT algorithm, all replicas run in succession of configuration named a view. In a certain view, one replica serves as a primary node and other replicas serve as backup nodes. Views are consecutively numbered numbers. The primary node can be calculated by using a formula p=v mod |R|, where v is a view number, p is a replica number, and |R| is a quantity of replica sets. In this algorithm, assume that when a maximum of replicas (that is, nodes) fail, security and activity can be ensured in an asynchronous system if a total of at least 3f+1 replicas are present. A set of a specific quantity of replicas needed to ensure data consistency and fault tolerance needs for all replicas is usually a set including most nodes in a distributed system, forming a quorum. For example, when a total quantity n of nodes is 3f+1 (n=3f+2 or n=3f can also exist, but these cases usually do not improve fault tolerance effects), the quorum is 2f+1. As such, for a distributed system that includes four nodes, any three nodes can form a quorum.

A PBFT protocol includes two processes: a normal case phase and a view change phase. FIG. 2 is a flowchart illustrating a normal case phase process. The normal case phase mainly includes three phases: pre-prepare, prepare, and commit. A node 3 can represent, for example, a down node (indicated by x in FIG. 2). When the primary node fails, the view change process needs to be started. Therefore, when the system is faulty, state adjustment is performed to obtain a new primary node. If the primary node goes offline or acts maliciously and does not broadcast a request of a client device, the client device can set a timeout mechanism. If timeout occurs, the client device can broadcast a request message to all replica nodes. After detecting that the primary node acts maliciously or goes offline, the replica node can initiate a view change phase to change the primary node (usually briefly referred to as “change the primary”). In addition, a consensus process in the three phases of pre-prepare, prepare, and commit may fail due to an incorrect proposal initiated by the primary node, or an agreement on the quorum quantity (for example, 2f+1 in 3f+1 nodes) may not be reached in the prepare and commit phases, that is, the consensus cannot be completed. In these cases, the view change phase can also be initiated to change the primary node.

The PBFT algorithm is a partial synchronous protocol, and is characterized by an assumption that the network is initially asynchronous but can become synchronous from a certain moment. To reach consensus on the same proposal among different nodes in the network, a simplest way is to dispose a primary node, and the primary node unifies opinions of various nodes. A timer is disposed to prevent the primary node from making mistakes. In the PBFT protocol, if the normal case phase is not completed within limited time, the backups are triggered to initiate the view change phase to change the primary node. In the PBFT protocol, the primary node is fixed at a position. All requests can be first sent to the primary node, and then broadcast by the primary node to other consensus nodes. In addition to introducing additional latency in sending requests to the primary node, ingress and egress bandwidth of the primary node can also be a performance bottleneck.

In this type of single-primary node type protocol such as PBFT, only the primary node can initiate a consensus proposal in the same consensus, and other nodes do not have a capability to initiate a consensus proposal. Alternatively, if the other nodes also have a proposal, the proposal needs to be forwarded to the primary node, and the primary node initiates the proposal instead. The former is unfair to the power of the consensus nodes to construct blocks, and the latter increases the pressure on the egress bandwidth of the primary node, although the backup node can also initiate a proposal. Neither is particularly suitable for a case in which most consensus nodes need to initiate a consensus proposal.

In contrast, the HoneyBadgerBFT (also usually briefly referred to as HBBFT) algorithm is an asynchronous protocol. The asynchronous protocol is applicable to asynchronous networks, that is, messages between nodes in the network can be arbitrarily delayed, but eventually arrive. The timer is removed from the HoneyBadgerBFT protocol, but execution of the protocol is driven by messages. In addition, all nodes in the HoneyBadgerBFT protocol are equal, and there is no distinction between the primary node and the backup node, that is, that is no primary change process. In an asynchronous network consensus protocol such as HBBFT, there is no concept of primary node, and each node can propose a request and attempt to construct a block. Therefore, the asynchronous network protocol alleviates a problem of fairness and a single node bottleneck to a certain extent.

FIG. 3 is a flowchart from a perspective of a single node in a HoneyBadgerBFT protocol. Actually, as mentioned above, all nodes in the HoneyBadgerBFT protocol are peers, that is, all the nodes can execute the process shown in FIG. 3. As shown in FIG. 3, from the perspective of a single node, the HoneyBadgerBFT protocol mainly includes two phases, namely, reliable broadcast (RBC) and asynchronous binary agreement (ABA, also referred to as “01 asynchronous consensus”). In addition, there is an asynchronous common subset (ACS) protocol above the RBC and the ABA. The RBC phase includes at least three rounds of message interaction: Rval, Echo, and Ready. The ABA phase includes at least three rounds of message interaction: Bval, Aux, and Coin. The RBC uses the three rounds of message interaction to ensure a reliable proposal broadcast. The ABA first conducts two rounds of voting (Bval and AUX messages) and then unifies proposals of the nodes with the help of a coin flip, to bypass needs of the partial synchronous protocol on network synchronization.

One time of HoneyBadgerBFT consensus goes through the RBC phase and at least one ABA phase. In a better case, there is a ½ probability that a current HoneyBadgerBFT consensus process can be terminated. As such, six rounds are needed to complete a consensus. In addition, there is a ¼ probability that another ABA process is executed, such as the second ABA process (the ABA process represented by rounds 7, 8, and 9) in FIG. 3. There is a ¼ probability that the process ends in the second round, and there is at least 1/4 probability that the current HoneyBadgerBFT consensus process can end. As such, nine rounds are needed to complete a consensus. After the second ABA process, there is an overall 1/8 probability that another ABA process is executed, and so on.

That is, the HoneyBadgerBFT protocol includes at least one RBC (three rounds) and one ABA (three rounds). If a voting result of the ABA is inconsistent with a coin flip result, the protocol enters a new round of ABA (at least three additional rounds).

It can be seen that the coin flip mechanism introduced by the HoneyBadgerBFT protocol brings uncertainty to the consensus rounds, which may cause an increase in consensus latency.

In addition, for one final generated block (corresponding to one epoch), one node can run one ACS and n RBCs+n ABAs, where n is a quantity of consensus nodes, one RBC and one ABA correspond to a consensus proposal initiated by the node, and the other n-1 RBCs and n-1 ABAs correspond to consensus proposals initiated by the other n-1 nodes. That is, for one epoch, a node further cooperates to complete consensus proposals initiated by other nodes while initiating a consensus proposal. As such, for one node, after at least n-f RBCs are completed, a completion status (indicated by a Ready message) of these RBCs is sent to the ACS, and further the ACS assigns an initial value to a corresponding ABA and starts a corresponding ABA process. After the ABA is completed for at least n-f consensus proposals, if the RBC is still not completed for the remaining consensus proposals, an initial value of 0 is assigned, to further perform an ABA process that corresponds to the proposal. From a global perspective, at least n-f nodes execute the above-mentioned same consensus process (a process of initiating proposals by at least n-f different nodes), and finally the ACS sorts, after collecting ABA results of the proposals, proposals with ABA results of 1 according to a certain rule and then outputs the proposals.

In the above-mentioned process, in contrast to the PBFT protocol, strong proposal needs are imposed on each node participating in the consensus, for example, the node participating in the consensus needs to initiate a proposal in every epoch, regardless of whether the node actually has a proposal. If the node actually has no proposal, the node still needs to initiate a proposal request with empty content (this empty proposal request can be encrypted in the RBC, so that other nodes cannot determine the content of the proposal, thereby preventing a malicious node from selectively assigning a value for an input or an output in an ABA process because the malicious node can see the content of the proposal). Even if the node is a failed node and cannot initiate a proposal, there should still be a position in an ACS of the other nodes for a proposal that corresponds to the node. Specifically, after all of the other nodes execute at least a quorum of ABAs and all reach consensus of 1, if a quorum of ready messages of an RBC phase that corresponds to a proposal of the node are still not received, the ACS needs to assign an initial value of an ABA that corresponds to the proposal of the node to 0, and then an ABA process is executed. As such, the other nodes further need to cooperate in completing the ABA process of the proposal that corresponds to the failed node.

In addition, a conventional asynchronous consensus protocol represented by HoneyBadgerBFT usually adopts a block formation method in which a pending-consensus block is specified by using a block identifier and a proposal is jointly initiated by all consensus nodes for the block that corresponds to the block identifier.

The HoneyBadgerBFT protocol is used as an example. Messages interacting in the RBC and ABA phases usually need to include the block identifier of the pending-consensus block. The consensus nodes can jointly propose, through interaction of the RBC and ABA phases, a transaction list to the block that corresponds to the block identifier.

According to the conventional block formation method, a consensus process of a proposal of any consensus node for the block needs to wait for, and cooperate with, consensus of proposals of other consensus nodes for the block for completion. Even a consensus node that has no proposal needs to propose a consensus proposal with empty content. Consequently, for proposals of some of the consensus nodes with large network communication latency for the block, completion of consensus processes and output of consensus results usually cannot be quickly and efficiently performed, and the consensus nodes may even lose the right to construct the block.

Specifically, all the consensus nodes in the blockchain system can perform, based on a consensus protocol, consensus processing on transactions included in a new block to be connected to the chained block structure, to ensure that the consensus nodes reach an agreement on content and order of the transactions included in the block. After the consensus is completed, the consensus nodes can execute the transactions included in the block in order and finalize the block after confirming that transaction execution results of the consensus nodes are consistent. Finalization means that the transactions included in the block are executed and completed and the transaction execution results are recognized by all the consensus nodes (or a particular quantity of consensus nodes, such as two-thirds of the consensus nodes).

In the asynchronous consensus protocol, each consensus node in the blockchain system can locally maintain a transaction pool. The local transaction pool maintained by each consensus node can store transactions pending-consensus transactions consensus is to be reached. Transactions in local transaction pools maintained by different consensus nodes may be entirely or partially the same. In this case, each consensus node can randomly select several transactions from the local transaction pool maintained by the consensus node and propose these transactions for the pending-consensus block. That is, after the consensus is completed, transactions included in the block are the transactions proposed by each consensus node for the block.

However, when different consensus nodes propose transactions at the same moment or different moments closer to one another, it is highly likely that the consensus nodes select duplicate transactions from local transaction pools respectively maintained by the consensus nodes, which leads to duplication of transactions in a consensus process, thus resulting in the waste of resources in the consensus process. Furthermore, the block after the consensus is completed may also include duplicate transactions, which causes the same transaction to be executed a plurality of times, thus resulting in an error in a transaction execution result. A transfer transaction is used as an example. Assume that 10 yuan can be transferred from a blockchain account A to a blockchain account B by executing the transfer transaction. In this case, when the transfer transaction appears twice in the block after the consensus is completed, the transaction is executed twice. What is actually achieved is a transfer of 20 yuan from the blockchain account A to the blockchain account B, causing losses to the blockchain account A. In actual applications, a smaller quantity of transactions in a transaction pool indicates a higher transaction duplication rate in the consensus process and the more serious waste of the resources in the consensus process.

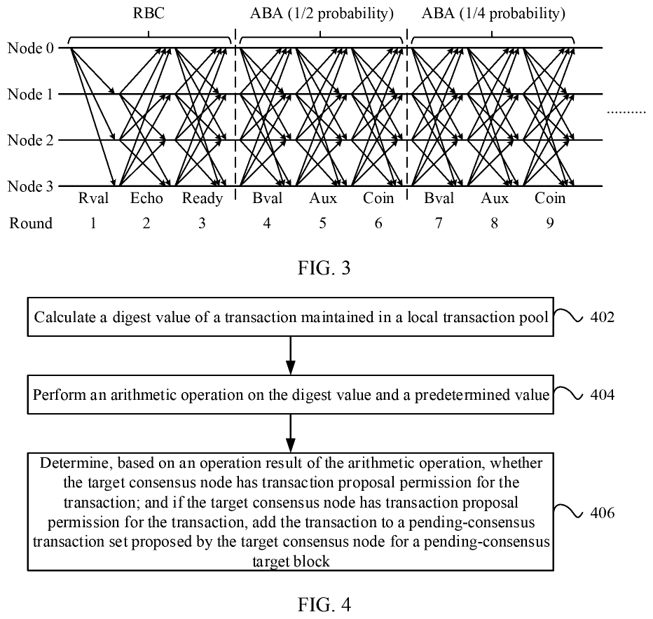

Referring to FIG. 4, FIG. 4 is a flowchart illustrating a transaction proposal method in a blockchain system, according to one or more example embodiments of this application.

This application provides an embodiment of a transaction proposal method in a blockchain system. In this embodiment, the blockchain system can include a plurality of consensus nodes that have transaction proposal permission. In this case, the transaction proposal method in the blockchain system can be applied to any consensus node (which can be referred to as a target consensus node) that has transaction proposal permission in the blockchain system.

In an illustrated implementation, the above-mentioned blockchain system can specifically be a blockchain system that adopts an asynchronous consensus protocol such as HoneyBadgerBFT, where each consensus node can propose a transaction and try to construct a block, that is, the consensus node has transaction proposal permission. For a specific implementation of the HoneyBadgerBFT protocol, references can be made to the above-mentioned content in this application. Details are omitted here for simplicity in this application.

It is worthwhile to note that each consensus node that has transaction proposal permission in the above-mentioned blockchain system can locally maintain a transaction pool (which can be referred to as a local transaction pool). The local transaction pool can include several pending-consensus transactions. The local transaction pool of each consensus node can include duplicate transactions.

As shown in FIG. 4, the transaction proposal method in the above-mentioned blockchain system can specifically include: Step 402: Calculate a digest value of a transaction maintained in a local transaction pool.

In this embodiment, the above-mentioned target consensus node can calculate a digest value of each transaction for all transactions maintained in a local transaction pool thereof, or for a part of all the transactions maintained in the local transaction pool thereof.

For example, assume that the local transaction pool maintained by the target consensus node can be denoted as T={t_1, t_2, . . . , t_k, . . . }. In this case, the target consensus node can calculate a digest value of any transaction t_k in the local transaction pool T.

In actual applications, for any transaction, a hash algorithm such as a SHA256 algorithm can be used to perform hash calculation on the transaction, and an obtained hash value is used as a digest value of the transaction.

Still refer to the above-mentioned example. The digest value of any transaction t_k in the local transaction pool T can be denoted as h_k=hash (t_k), where hash ( ) represents a hash function.

In an illustrated implementation, for a particular transaction maintained in the above-mentioned local transaction pool, when calculating a digest value of the transaction, the above-mentioned target consensus node can specifically perform data concatenation on transaction content of the transaction and a block identifier of a pending-consensus block (which can be referred to as a target block), and calculate a digest value of data content obtained through the data concatenation, so that the digest value of the data content obtained through the data concatenation can be used as the digest value of the transaction.

Still refer to the above-mentioned example. Assume that a block identifier of the above-mentioned pending-consensus target block can be denoted as r. In this case, the digest value of any transaction t_k in the local transaction pool T can be denoted as h_k=hash (t_k|r). t_k|r represents data content obtained through data concatenation performed on transaction content of the transaction t_k and a block identifier r of the target block.

For a blockchain, a block height is a quantity of blocks connected to a chained block structure. However, for any block in the blockchain, a block height of the block can be used as an identifier of the block. The block is often considered to have two identifiers, where one identifier is a hash value of a block header and the other identifier is the block height. The hash value of the block header is obtained by performing secondary hash calculation on the block header through the SHA256 algorithm, etc. The hash value of the block header can uniquely identify a block, and any node in the blockchain system can independently acquire the hash value of the block header by performing hash calculation on the block header. The block height refers to a position of a block in the blockchain. The block height is not an identifier that uniquely identifies a block. Although a block always has a clear and fixed block height, a block height does not always identify a unique block. Two or more blocks may have the same block height, that is, the blocks compete for the same position in the blockchain.

In an illustrated implementation, a block number can be set for each block in the blockchain to identify the block by the block number, to be specific, one block number can identify one block, and the block number can be used as a block identifier of the block. In actual applications, the block number can be the block height or a unique number that corresponds to the hash value of the block header. Implementations are not limited in this application.

It is worthwhile to note that since block identifiers of pending-consensus blocks in all rounds of consensus processes are different, a digest value of data content obtained through data concatenation performed on transaction content of a particular transaction and a block identifier of a pending-consensus block in a current consensus process is different from a digest value of data content obtained through data concatenation performed on the transaction content of the transaction and a block identifier of a pending-consensus block in a next consensus process. As such, when consensus for the transaction does not succeed in the current consensus process, in the next consensus process, the transaction can be allocated to another consensus node as a pending-consensus transaction proposed by the another consensus node for the pending-consensus block, so that consensus processing is performed again on the transaction, thereby avoiding a problem that the transaction always cannot be proposed due to a malicious behavior or breakdown of a consensus node.

Step 404: Perform an arithmetic operation on the digest value and a predetermined value.

In this embodiment, for a certain transaction maintained in the above-mentioned local transaction pool, when calculating a digest value of the transaction, the above-mentioned target consensus node can perform an arithmetic operation on the digest value of the transaction and a predetermined value, to obtain an operation result that is of the arithmetic operation and that corresponds to the transaction.

It is worthwhile to note that the above-mentioned predetermined value can be set based on an actual need. The need can be how many consensus nodes in the above-mentioned blockchain system need to propose the transaction, or which specific consensus nodes in the blockchain system need to propose the transaction. Implementations are not limited in this application. Correspondingly, for any transaction maintained in the above-mentioned local transaction pool, the above-mentioned arithmetic operation is performed on a digest value of the transaction and a predetermined value, to determine an appropriate consensus node for the transaction from these consensus nodes, so that the transaction can be proposed by the appropriate consensus node, in other words, the transaction is used as the pending-consensus transaction proposed by the consensus node for the pending-consensus block.

In an illustrated implementation, the above-mentioned predetermined value can specifically be a quantity value (which can be referred to as a target quantity value) that corresponds to a total quantity of the consensus nodes in the blockchain system. In this case, for a certain transaction maintained in the above-mentioned local transaction pool, when performing an arithmetic operation on a digest value of the transaction and a predetermined value, the above-mentioned target consensus node can specifically perform the arithmetic operation on the digest value of the transaction and the target quantity value, to obtain an operation result that is of the arithmetic operation and that corresponds to the transaction.

The predetermined value for performing the arithmetic operation is set to the quantity value that corresponds to the total quantity of the consensus nodes in the blockchain system, to determine, from a plurality of consensus nodes that maintain the same transaction in local transaction pools, an appropriate consensus node for the transaction based on the operation result of the arithmetic operation, and the consensus node uses the transaction as the pending-consensus transaction proposed by the consensus node for the pending-consensus block, to avoid that the plurality of consensus nodes all select the transaction from respective local transaction pools thereof and propose the transaction for the pending-consensus block, so that the probability of different consensus nodes proposing the same transaction can be further reduced, thereby reducing a transaction duplication rate in a consensus process, reducing the waste of resources in the consensus process, preventing a block after completion of the consensus from including duplicate transactions, and alleviating a problem of the same transaction being executed a plurality of times.

In an illustrated implementation, the node identifier of each consensus node in the above-mentioned blockchain system can be set to an unsigned integer not greater than the target quantity value. For example, assume that the blockchain system includes three consensus nodes. In this case, the target quantity value is 3, and node identifiers of the three consensus nodes can respectively be 0, 1, and 2, or node identifiers of the three consensus nodes can respectively be 1, 2, and 3. In this case, for a certain transaction maintained in the above-mentioned local transaction pool, when performing an arithmetic operation on a digest value of the transaction and the target quantity value, the above-mentioned target consensus node can specifically perform a mod operation on the digest value of the transaction and the target quantity value, so that a value that corresponds to an operation result of the arithmetic operation is less than the target quantity value.

Still refer to the above-mentioned example. Assume that the total quantity of the consensus nodes in the above-mentioned blockchain system can be denoted as n (that is, the target quantity is a value of n). In this case, a mod operation performed on the digest value of any transaction t_k in the local transaction pool T and the target quantity value can be denoted as h_k mod n. In other words, n is used as a dividend to calculate a remainder when h_k is divided by n.

It is worthwhile to note that the mod operation is a remainder operation. A remainder in the remainder operation is less than a dividend. Therefore, the mod operation is performed on a digest value of each transaction in a local transaction pool of each consensus node and the total quantity of the consensus nodes in the blockchain system, to ensure that an operation result of the mod operation that corresponds to each transaction is less than the total quantity of the consensus nodes in the blockchain system. In addition, the node identifier of each consensus node in the blockchain system is not greater than the total quantity of the consensus nodes in the blockchain system. Therefore, a mapping relationship between the operation result and the node identifier can be easily determined, to conveniently and quickly determine, from a plurality of consensus nodes that maintain the same transaction in local transaction pools, an appropriate consensus node for the transaction based on the mapping relationship.

Step 406: Determine, based on the operation result of the arithmetic operation, whether the target consensus node has transaction proposal permission for the transaction; and if the target consensus node has transaction proposal permission for the transaction, add the transaction to a pending-consensus transaction set proposed by the target consensus node for the pending-consensus target block.

In this embodiment, for a certain transaction maintained in the above-mentioned local transaction pool, when obtaining an operation result that is of the above-mentioned arithmetic operation and that corresponds to the transaction, the above-mentioned target consensus node can determine, based on the operation result, whether the target consensus node has transaction proposal permission for the transaction; and if having the transaction proposal permission for the transaction, the target consensus node can add the transaction to the pending-consensus transaction set proposed by the target consensus node for the pending-consensus block (which can be referred to as the target block).

In an illustrated implementation, when the above-mentioned target consensus node determines, based on the operation result that is of the above-mentioned arithmetic operation and that corresponds to the transaction, whether the target consensus node has transaction proposal permission for the transaction, the target consensus node can specifically match the operation result of the arithmetic operation against the node identifier of the target consensus node, to determine, based on a matching result, whether the target consensus node has the transaction proposal permission.

That is, each consensus node in the above-mentioned blockchain system can determine, based on a result of matching an operation result that is of the above-mentioned arithmetic operation and that corresponds to a certain transaction maintained in a local transaction pool thereof with a node identifier of the consensus node, whether to add the transaction to a pending-consensus transaction set proposed by the consensus node for the pending-consensus block. For the transaction, the result is equivalent to determining an appropriate consensus node for the transaction from the consensus nodes in the blockchain system, so that the appropriate consensus node can propose the transaction, in other words, use the transaction as the pending-consensus transaction proposed by the consensus node for the pending-consensus block.

In an illustrated implementation, on the one hand, an operation result of the above-mentioned arithmetic operation performed on the digest value of each transaction maintained in the above-mentioned local transaction pool and the above-mentioned target quantity value can be an unsigned integer less than the target quantity value; on the other hand, the node identifier of each consensus node in the above-mentioned blockchain system can also be set to an unsigned integer less than the target quantity value. In this case, for a certain transaction maintained in the above-mentioned local transaction pool, when the above-mentioned target consensus node matches the operation result of the arithmetic operation against the node identifier of the target consensus node, and determines, based on a matching result, whether to add the transaction to the pending-consensus transaction set proposed by the target consensus node for the pending-consensus target block, the target consensus node can specifically perform value matching on a first value that corresponds to the operation result of the arithmetic operation and a second value that corresponds to the node identifier of the target consensus node, and if the first value and the second value match each other, for example, the first value and the second value are the same, can add the transaction to the pending-consensus transaction set proposed by the target consensus node for the pending-consensus target block.

Still refer to the above-mentioned example. Assume that the node identifier of the above-mentioned target consensus node can be denoted as i. For any transaction t_k in the local transaction pool T, when i==(h_k mod n), the transaction t_k can be added to the pending-consensus transaction set proposed by the target consensus node for the pending-consensus target block.==is a relational operator and is used to determine whether two values are the same.

The operation result that is of the arithmetic operation and that corresponds to each transaction in the local transaction pool of each consensus node and the node identifier of each consensus node in the blockchain system are each an unsigned integer less than the quantity value that corresponds to the total quantity of the consensus nodes in the blockchain system, and whether the consensus node can propose a transaction can be determined by determining whether the operation result is the same as the node identifier. Therefore, on the one hand, a mapping relationship between the operation result and the node identifier can be easily determined, so that an appropriate consensus node can be conveniently and quickly determined, from a plurality of consensus nodes that maintain the same transaction in local transaction pools, for the transaction based on the mapping relationship, and on the other hand, that the plurality of consensus nodes all select the transaction from respective local transaction pools thereof and propose the transaction for the pending-consensus block can be avoided, so that the probability of different consensus nodes proposing the same transaction can be further reduced, thereby reducing a transaction duplication rate in a consensus process, reducing the waste of resources in the consensus process, preventing a block after completion of the consensus from including duplicate transactions, and alleviating a problem of the same transaction being executed a plurality of times.

In an illustrated implementation, on the one hand, the operation result of the arithmetic operation performed on the digest value of each transaction maintained in the above-mentioned local transaction pool and the above-mentioned target quantity value can be an unsigned integer not less than the target quantity value; on the other hand, the node identifier of each consensus node in the above-mentioned blockchain system can be set to an unsigned integer less than the target quantity value. In this case, for a certain transaction maintained in the above-mentioned local transaction pool, when the above-mentioned target consensus node matches the operation result of the arithmetic operation against the node identifier of the target consensus node, and determines, based on a matching result, whether to add the transaction to the pending-consensus transaction set proposed by the target consensus node for the pending-consensus target block, the target consensus node can specifically match a third value that corresponds to the operation result of the arithmetic operation with a value range bound to the node identifier of the target consensus node, where the value range can be used to determine a transaction proposed by the target consensus node, and if the third value hits the value range, can add the transaction to the pending-consensus transaction set proposed by the target consensus node for the pending-consensus target block.

The operation result that is of the arithmetic operation and that corresponds to each transaction in the local transaction pool of each consensus node is an unsigned integer not less than the quantity value that corresponds to the total quantity of the consensus nodes in the blockchain system, the node identifier of each consensus node in the blockchain system is an unsigned integer less than the quantity value that corresponds to the total quantity of the consensus nodes in the blockchain system, and whether the consensus node can propose a transaction can be determined by determining whether the operation result hits the value range bound to the node identifier. Therefore, on the one hand, an appropriate consensus node can be conveniently and quickly determined, from a plurality of consensus nodes that maintain the same transaction in local transaction pools, for the transaction based on whether the operation result hits the value range bound to the node identifier, and on the other hand, that the plurality of consensus nodes all select the transaction from respective local transaction pools thereof and propose the transaction for the pending-consensus block can be avoided, so that the probability of different consensus nodes proposing the same transaction can be further reduced, thereby reducing a transaction duplication rate in a consensus process, reducing the waste of resources in the consensus process, preventing a block after completion of the consensus from including duplicate transactions, and alleviating a problem of the same transaction being executed a plurality of times.

In an illustrated implementation, the above-mentioned target consensus node can further determine whether a quantity of transactions in the pending-consensus transaction set proposed for the above-mentioned pending-consensus target block reaches a predetermined threshold; and if the quantity of transactions in the pending-consensus transaction set proposed for the above-mentioned pending-consensus target block reaches the predetermined threshold, can run a consensus protocol (for example, a HoneyBadgerBFT protocol) adopted by the above-mentioned blockchain system, to transmit the transaction set to other consensus nodes in the blockchain system, to initiate consensus processing on the transaction set.

The quantity of transactions in the pending-consensus transaction set proposed by each consensus node in the blockchain system for the pending-consensus block is limited, so that consensus processing can be promptly initiated for the transaction set when the quantity of transactions in the transaction set that corresponds to each consensus node reaches a certain quantity, thereby alleviating a problem of low consensus efficiency caused by a large quantity of transactions in the local transaction pool of each consensus node.

In an illustrated implementation, the above-mentioned target consensus node can transmit the pending-consensus transaction set proposed by the target consensus node for the above-mentioned pending-consensus target block to other consensus nodes in the above-mentioned blockchain system, to initiate consensus processing on the transaction set. Correspondingly, the target consensus node can receive a pending-consensus transaction set proposed by any another consensus node in the blockchain system for the pending-consensus target block. Subsequently, the target consensus node can first calculate a digest value of a transaction in the transaction set, and perform the above-mentioned arithmetic operation on the digest value and the above-mentioned target quantity value; then match an operation result obtained through the arithmetic operation against the node identifier of the target consensus node, and determine, based on a matching result, whether the another consensus node is a malicious node; and if the another consensus node is a malicious node, can store the another consensus node as a malicious node; or if the another consensus node is not a malicious node, can run a consensus protocol (for example, a HoneyBadgerBFT protocol) adopted by the blockchain system, to perform consensus processing on the transaction set.

Any consensus node in the blockchain system can calculate a digest value of a transaction maintained in a local transaction pool, perform the arithmetic operation on the digest value and a predetermined value, match an operation result of the arithmetic operation with a node identifier of the consensus node, and determine, based on a matching result, whether to add the transaction to a transaction set proposed by the consensus node for the pending-consensus target block. Therefore, when receiving a pending-consensus transaction set proposed by any another consensus node in the blockchain system for the pending-consensus target block, the consensus node can verify a transaction in the transaction set in the same way, to be specific, matching an operation result of the arithmetic operation performed on a digest value of the transaction in the transaction set and the predetermined value with a node identifier of the another consensus node, to determine whether the another consensus node is a malicious node, so that consensus processing on a transaction set proposed by the malicious node can be avoided.

In an illustrated implementation, similar to the specific implementation of step 402, for a pending-consensus transaction set proposed by any another consensus node in the above-mentioned blockchain system for the pending-consensus target block, when calculating a digest value of a transaction in the transaction set, the above-mentioned target consensus node can specifically perform data concatenation on transaction content of the transaction in the transaction set and the block identifier of the target block, and calculate a digest value of the data content obtained through the data concatenation as the digest value of the transaction.

In an illustrated implementation, similar to the specific implementation of step 406, for a pending-consensus transaction set proposed by any another consensus node in the above-mentioned blockchain system for the pending-consensus target block, on the one hand, an operation result of the above-mentioned arithmetic operation performed on a digest value of a transaction in the transaction set and the above-mentioned target quantity value can be an unsigned integer less than the target quantity value; on the other hand, the node identifier of each consensus node in the above-mentioned blockchain system can also be set to an unsigned integer less than that target quantity value. In this case, when the above-mentioned target consensus node matches the operation result of the arithmetic operation against the node identifier of the target consensus node and determines, based on a matching result, whether the another consensus node is a malicious node, the target consensus node can further specifically perform value matching on a fourth value that corresponds to the operation result of the arithmetic operation and a fifth value that corresponds to a node identifier of the another consensus node; and if the fourth value matches the fifth value, for example, the fourth value is the same as the fifth value, can determine that the another consensus node is not a malicious node, or on the contrary, can determine that the another consensus node is a malicious node.

In an illustrated implementation, similar to the specific implementation of step 406, for a pending-consensus transaction set proposed by any another consensus node in the above-mentioned blockchain system for the pending-consensus target block, on the one hand, an operation result of the arithmetic operation performed on a digest value of a transaction in the transaction set and the above-mentioned target quantity value can be an unsigned integer not less than the target quantity value; on the other hand, the node identifier of each consensus node in the above-mentioned blockchain system can be set to an unsigned integer less than the target quantity value. In this case, when the above-mentioned target consensus node matches the operation result of the arithmetic operation against the node identifier of the target consensus node and determines, based on a matching result, whether the another consensus node is a malicious node, the target consensus node can specifically match a sixth value that corresponds to the operation result of the arithmetic operation and a value range bound to a node identifier of the another consensus node, where the value range can be used to determine a transaction proposed by the another consensus node, and if the sixth value hits the value range, can determine that the another consensus node is not a malicious node, or on the contrary, can determine that the another consensus node is a malicious node.

In an illustrated implementation, the above-mentioned target consensus node can store the malicious node. Therefore, the target consensus node can further determine whether a pending-consensus transaction set proposed by the stored malicious node for the pending-consensus target block is received; and if the pending-consensus transaction set proposed by the stored malicious node for the pending-consensus target block is received, can skip performing consensus voting on the transaction set, to directly avoid consensus processing on the transaction set proposed by the malicious node; or vote against approving the transaction set during a consensus voting phase, so that consensus on the transaction set proposed by the malicious node is caused to fail, and a block that includes the transaction set is not stored in the blockchain.

In an illustrated implementation, for any transaction in the local transaction pool of the above-mentioned target consensus node, to avoid that the target consensus node selects, after consensus on the transaction succeeds, the transaction again from the local transaction pool thereof and proposes the transaction for the pending-consensus block, the target consensus node can consider, when consensus processing on the pending-consensus transaction set proposed for the above-mentioned pending-consensus target block is passed, that consensus on the transaction set succeeds, thereby removing transactions in the transaction set from the local transaction pool thereof.

In the above-mentioned embodiments, the target consensus node in the blockchain system can calculate the digest value of the transaction maintained in the local transaction pool, and perform an arithmetic operation on the digest value and the predetermined value, to match the operation result of the arithmetic operation against the node identifier of the target consensus node, and determine, based on a matching result, whether to add the transaction in the pending-consensus transaction set proposed by the target consensus node for the pending-consensus target block.

By using the above-mentioned way, for any consensus node in the blockchain system that has the transaction proposal permission, the consensus node no longer needs to randomly select several transactions from a local transaction pool thereof for proposal, but can determine, for any transaction maintained in the local transaction pool thereof, whether to add the transaction to a transaction set proposed by the consensus node for the pending-consensus block. As such, it is equivalent in result to determining, from a plurality of consensus nodes that maintain the same transaction in local transaction pools, an appropriate consensus node for the transaction, and the consensus node uses the transaction as a pending-consensus transaction proposed by the consensus node for the pending-consensus block, to avoid that the plurality of consensus nodes all select the transaction from respective local transaction pools thereof and propose the transaction for the pending-consensus block, so that the probability of different consensus nodes proposing the same transaction can be reduced, a transaction duplication rate in a consensus process can be reduced, the waste of resources in the consensus process can be reduced, and that a block after the completion of consensus includes duplicate transactions is avoided, thereby resolving a problem of the same transaction being executed a plurality of times.

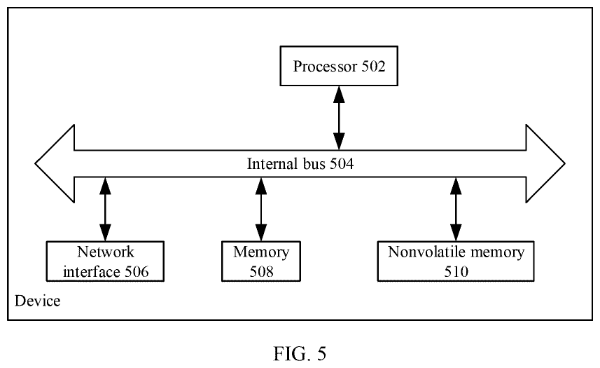

Referring to FIG. 5, FIG. 5 is a schematic structural diagram illustrating a device, according to one or more example embodiments of this application. In terms of hardware, the device includes a processor 502, an internal bus 504, a network interface 506, an internal memory 508, and a non-volatile memory 510, and certainly may further include other needed hardware. One or more embodiments of this application can be implemented in a software-based way, for example, the processor 502 reads a corresponding computer program from the non-volatile memory 510 to the internal memory 508, and then runs the computer program. Certainly, in addition to a software implementation, one or more embodiments of this application do not rule out other implementations, such as an implementation of a logic device or a combination of software and hardware. In other words, an execution body of the following processing procedure is not limited to each logical module, and can be hardware or a logic device.

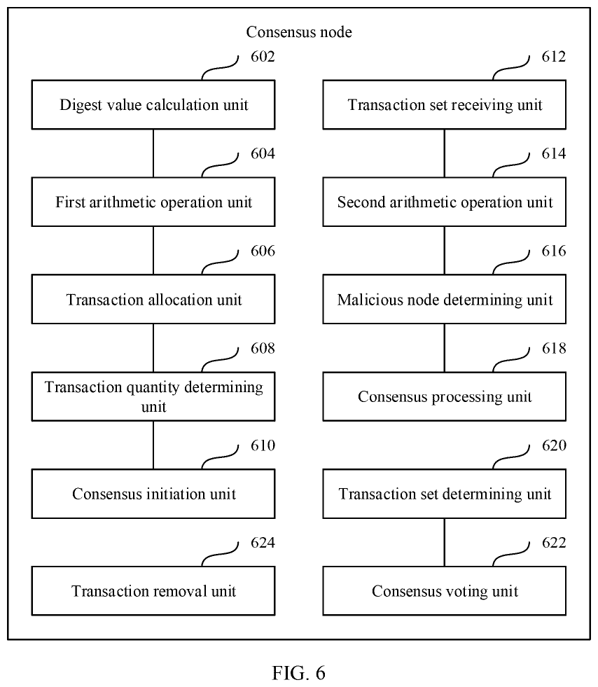

Referring to FIG. 6. FIG. 6 is a schematic architectural diagram illustrating a consensus node in a blockchain system, according to one or more example embodiments of this application.

This application further provides the embodiment of the consensus node in the blockchain system. In this embodiment, the consensus node in the above-mentioned blockchain system can specifically be the device shown in FIG. 5, to implement the technical solutions in this application. The blockchain system includes a plurality of consensus nodes that have transaction proposal permission; and local transaction pools of the consensus nodes that have transaction proposal permission in the blockchain system include duplicate transactions.

The above-mentioned consensus node has transaction proposal permission, as shown in FIG. 6; and includes: a digest value calculation unit 602, configured to calculate a digest value of a transaction maintained in a local transaction pool; a first arithmetic operation unit 604, configured to perform an arithmetic operation on the digest value and a predetermined value; and a transaction allocation unit 606, configured to determine, based on an operation result of the arithmetic operation, whether a target consensus node has transaction proposal permission for the transaction; and if the target consensus node has transaction proposal permission for the transaction, add the transaction to a pending-consensus transaction set proposed by the target consensus node for a pending-consensus target block.

Optionally, the digest value calculation unit 602 is configured to perform data concatenation on transaction content of the transaction maintained in the local transaction pool and a block identifier of the target block, and calculate, as the digest value of the transaction, a digest value of data content obtained through the data concatenation.

Optionally, the predetermined value is a target quantity value that corresponds to a total quantity of the consensus nodes in the blockchain system; and the arithmetic operation unit 604 is configured to perform an arithmetic operation on the digest value and the target quantity value.

Optionally, a node identifier of each consensus node in the blockchain system is not greater than an unsigned integer of the target quantity value; and the arithmetic operation unit 604 is configured to perform a mod operation on the digest value and the target quantity value, so that a value that corresponds to an operation result of the arithmetic operation is less than the target quantity value.

Optionally, the transaction allocation unit 606 is configured to match the operation result of the arithmetic operation against a node identifier of the target consensus node, and determine, based on a matching result, whether the target consensus node has transaction proposal permission for the transaction.

Optionally, the operation result of the arithmetic operation and the node identifier of each consensus node in the blockchain system are each an unsigned integer less than the target quantity value; and the transaction allocation unit 606 is configured to perform value matching on a first value that corresponds to the operation result of the arithmetic operation and a second value that corresponds to the node identifier of the target consensus node; and if the first value and the second value are the same, determine that the target consensus node has transaction proposal permission for the transaction.

Optionally, the node identifier of each consensus node in the blockchain system is an unsigned integer less than the target quantity value, and the operation result of the arithmetic operation is an unsigned integer not less than the target quantity value; and the transaction allocation unit 606 is configured to match a third value that corresponds to the operation result of the arithmetic operation with a value range bound to the node identifier of the target consensus node, where the value range is used to determine a transaction proposed by the target consensus node; and if the third value hits the value range, determine that the target consensus node has transaction proposal permission for the transaction.

Optionally, the consensus node further includes: a transaction quantity determining unit 608, configured to determine whether a quantity of transactions in the transaction set reaches a predetermined threshold; and a consensus initiation unit 610, configured to: if the quantity of transactions in the transaction set reaches the predetermined threshold, initiate consensus processing on the transaction set by transmitting the transaction set to other consensus nodes by running an asynchronous consensus protocol.

Optionally, the consensus node further includes: a transaction set receiving unit 612, configured to receive a pending-consensus transaction set proposed by another consensus node for the pending-consensus target block; a second arithmetic operation unit 614, configured to calculate a digest value of a transaction in the transaction set, and perform the arithmetic operation on the digest value and the target quantity value; a malicious node determining unit 616, configured to match an operation result obtained through the arithmetic operation against the node identifier of the target consensus node, and determine, based on a matching result, whether the another consensus node is a malicious node; and a consensus processing unit 618, configured to: if the another consensus node is a malicious node, store the another consensus node as a malicious node; or if the another consensus node is not a malicious node, perform consensus processing on the transaction set by running the asynchronous consensus protocol.

Optionally, the second arithmetic operation unit 614 is configured to perform data concatenation on transaction content of the transaction in the transaction set and the block identifier of the target block, and calculate, as the digest value of the transaction, a digest value of data content obtained through the data concatenation.

Optionally, if the operation result of the arithmetic operation and the node identifier of each consensus node in the blockchain system are each an unsigned integer less than the target quantity value, the malicious node determining unit 616 is configured to perform value matching on a fourth value that corresponds to the operation result of the arithmetic operation and a fifth value that corresponds to a node identifier of the another consensus node; and if the fourth value and the fifth value are the same, determine that the another consensus node is not a malicious node; or on the contrary, determine that the another consensus node is a malicious node.

Optionally, if the node identifier of each consensus node in the blockchain system is an unsigned integer less than the target quantity value, and the operation result of the arithmetic operation is an unsigned integer not less than the target quantity value, the malicious node determining unit 616 is configured to match a sixth value that corresponds to the operation result of the arithmetic operation with a value range bound to a node identifier of the another consensus node; and if the sixth value hits the value range, determine that the another consensus node is not a malicious node; or on the contrary, determine that the another consensus node is a malicious node.

Optionally, the consensus node further includes: a transaction set determining unit 620, configured to determine whether a pending-consensus transaction set proposed by a stored malicious node for the pending-consensus target block is received; and a consensus voting unit 622, configured to: if the pending-consensus transaction set proposed by the stored malicious node for the pending-consensus target block is received, skip performing consensus voting on the transaction set; or vote against approving the transaction set during a consensus voting phase.

Optionally, the consensus node further includes a transaction removal unit 624, configured to remove transactions in the transaction set from the local transaction pool in response to a success of consensus processing on the transaction set.

Optionally, the blockchain system is a blockchain system that uses a HoneyBadgerBFT protocol.

This application further provides an embodiment of a blockchain system, including a consensus node. The blockchain system includes a plurality of consensus nodes that have transaction proposal permission; local transaction pools of the consensus nodes that have transaction proposal permission in the blockchain system include duplicate transactions; and any target consensus node that has transaction proposal permission in the blockchain system is configured to: calculate a digest value of a transaction maintained in a local transaction pool; perform an arithmetic operation on the digest value and a predetermined value; and determine, based on an operation result of the arithmetic operation, whether the target consensus node has transaction proposal permission for the transaction; and if the target consensus node has transaction proposal permission for the transaction, add the transaction to a pending-consensus transaction set proposed by the target consensus node for a pending-consensus target block.

Optionally, the target consensus node is configured to perform data concatenation on transaction content of the transaction maintained in the local transaction pool and a block identifier of the target block, and calculate, as the digest value of the transaction, a digest value of data content obtained through the data concatenation.

Optionally, the predetermined value is a target quantity value that corresponds to a total quantity of the consensus nodes in the blockchain system; and the target consensus node is configured to perform an arithmetic operation on the digest value and the target quantity value.

Optionally, a node identifier of each consensus node in the blockchain system is not greater than an unsigned integer of the target quantity value; and the target consensus node is configured to perform a mod operation on the digest value and the target quantity value, so that a value that corresponds to an operation result of the arithmetic operation is less than the target quantity value.

Optionally, the target consensus node is configured to match the operation result of the arithmetic operation against a node identifier of the target consensus node, and determine, based on a matching result, whether the target consensus node has transaction proposal permission for the transaction.

Optionally, the operation result of the arithmetic operation and the node identifier of each consensus node in the blockchain system are each an unsigned integer less than the target quantity value; and the target consensus node is configured to perform value matching on a first value that corresponds to the operation result of the arithmetic operation and a second value that corresponds to the node identifier of the target consensus node; and if the first value and the second value are the same, determine that the target consensus node has transaction proposal permission for the transaction.

Optionally, the node identifier of each consensus node in the blockchain system is an unsigned integer less than the target quantity value, and the operation result of the arithmetic operation is an unsigned integer not less than the target quantity value; and the target consensus node is configured to match a third value that corresponds to the operation result of the arithmetic operation with a value range bound to the node identifier of the target consensus node, where the value range is used to determine a transaction proposed by the target consensus node; and if the third value hits the value range, determine that the target consensus node has transaction proposal permission for the transaction.

Optionally, the target consensus node is further configured to determine whether a quantity of transactions in the transaction set reaches a predetermined threshold; and if the quantity of transactions in the transaction set reaches the predetermined threshold, initiate consensus processing on the transaction set by transmitting the transaction set to other consensus nodes by running an asynchronous consensus protocol.

Optionally, the target consensus node is further configured to receive a pending-consensus transaction set proposed by another consensus node for the pending-consensus target block; calculate a digest value of a transaction in the transaction set, and perform the arithmetic operation on the digest value and the target quantity value; match an operation result obtained through the arithmetic operation against the node identifier of the target consensus node, and determine, based on a matching result, whether the another consensus node is a malicious node; and if the another consensus node is a malicious node, store the another consensus node as a malicious node; or if the another consensus node is not a malicious node, perform consensus processing on the transaction set by running the asynchronous consensus protocol.

Optionally, the target consensus node is configured to perform data concatenation on transaction content of the transaction in the transaction set and the block identifier of the target block, and calculate, as the digest value of the transaction, a digest value of data content obtained through the data concatenation.

Optionally, if the operation result of the arithmetic operation and the node identifier of each consensus node in the blockchain system are each an unsigned integer less than the target quantity value, the target consensus node is configured to perform value matching on a fourth value that corresponds to the operation result of the arithmetic operation and a fifth value that corresponds to a node identifier of the another consensus node; and if the fourth value and the fifth value are the same, determine that the another consensus node is not a malicious node; or on the contrary, determine that the another consensus node is a malicious node.

Optionally, if the node identifier of each consensus node in the blockchain system is an unsigned integer less than the target quantity value, and the operation result of the arithmetic operation is an unsigned integer not less than the target quantity value, the target consensus node is configured to match a sixth value that corresponds to the operation result of the arithmetic operation with a value range bound to a node identifier of the another consensus node; and if the sixth value hits the value range, determine that the another consensus node is not a malicious node; or on the contrary, determine that the another consensus node is a malicious node.

Optionally, the target consensus node is further configured to determine whether a pending-consensus transaction set proposed by a stored malicious node for the pending-consensus target block is received; and if the pending-consensus transaction set proposed by the stored malicious node for the pending-consensus target block is received, skip performing consensus voting on the transaction set; or vote against approving the transaction set during a consensus voting phase.

Optionally, the target consensus node is further configured to remove transactions in the transaction set from the local transaction pool in response to a success of consensus processing on the transaction set.

Optionally, the blockchain system is a blockchain system that uses a HoneyBadgerBFT protocol.

In the 1990s, it was clear whether an improvement of a technology was a hardware improvement (for example, an improvement of the circuit structure such as diodes, transistors, and switches) or a software improvement (an improvement of the method flow). However, with the development of technology, the improvement of many methods can be regarded as a direct improvement of the hardware circuit structure. Almost all designers get the corresponding hardware circuit structure by programming the improved method flow into the hardware circuit. Hence, it cannot say that an improvement of a method flow cannot be implemented using a hardware entity module. For example, a programmable logic device (PLD) (for example, a field programmable gate array (FPGA)) is such an integrated circuit, and a logical function thereof is determined by a user through device programming. The designer performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs instead of only one HDL, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicon Labs C8051F320. The memory controller can also be implemented as a part of control logic of a storage. It is also known to a person skilled in the art that, in addition to implementing the controller in a purely computer-readable program code manner, it is entirely possible to perform the same functions of the controller in the form of logic gates, switches, ASIC, programmable logic controllers, embedded microcontrollers, etc. by logic programming the method steps. Hence, this controller can be considered to be a hardware component, while an apparatus included therein for implementing various functions can also be considered as the structure in the hardware component. Or the apparatus for implementing various functions can even be considered as both a software module for implementing a method and the structure in the hardware component.

The system, apparatus, module, or unit stated in the embodiments above can specifically be implemented using a computer chip or entity, or may be implemented by a product having a certain function. A typical implementing device is a server system. Certainly, this application does not exclude that with the development of computer technology in the future, the computer that implements the functions of the above-mentioned embodiments may, for example, be a personal computer, a laptop computer, a vehicular human-computer interaction device, a cellular phone, a camera phone, a smart phone, a personal digital assistant, a media player, a navigation device, an E-mail device, a game console, a tablet computer, a wearable device, or a combination of any of these devices.

Although one or more embodiments of this application provide method operating steps as described in an embodiment or a flowchart, more or fewer operating steps may be included on the basis of conventional or noncreative means. The sequence of steps enumerated in the embodiments is only one way among multiple step execution sequences and does not represent a unique sequence of execution. When executed in an actual apparatus or end product, it may be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a set of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, and the like are used for indicating names, they do not indicate any particular order.

For the convenience of description, the above-mentioned apparatuses are divided into various modules according to functions for respective descriptions. Certainly, when implementing one or more of this application, functions of various modules can be realized in the same or more software and/or hardware, and the modules that achieve the same function can also be realized by a combination of multiple sub-modules or sub-units. The apparatus embodiments described above are only schematic, for example, the division of units is only a logical function division; in actual implementation, there may be other ways of division; for example, multiple units or assemblies can be combined or can be integrated into another system, or some features can be omitted, or not performed. In addition, the displayed or discussed mutual couplings or direct couplings or communication connections can be implemented by using some interfaces. The indirect couplings or communication connections between the apparatuses or units can be implemented in electronic, mechanical, or other forms.

This application is described based on the flowcharts and/or block diagrams of the method, the apparatus (system), and the computer program product based on the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided to a processor of a general-purpose computer, a special-purpose computer, an embedded processor, or another programmable data processing device to generate a machine, such that the instructions executed by the processor of the computer or another programmable data processing device generate an apparatus for implementing a specific function in one or more procedures in the flowcharts and/or one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

A person skilled in the art should know that one or more embodiments of this specification can be provided as a method, a system, or a computer program product. Therefore, one or more embodiments of this application may take a form of a hardware-only embodiment, a software-only embodiment, or an embodiment with a combination of software and hardware. Moreover, the one or more embodiments of this application may use the form of a computer program product implemented on one or more computer available storage media (including, but not limited to, disk storage, CD-ROM, optical memory, etc.), where the computer available program code is included.

The one or more embodiments of this application can be described in the general context of computer-executable instructions executed by a computer, for example, a program module. Usually, the program module includes a routine, a program, an object, a component, a data structure, etc. for executing a specific task or implementing a specific abstract data type. One or more embodiments of this application can also be practiced in a distributed computing environment. In the distributed computing environment, tasks are executed by remote processing devices that are connected through a communication network. In the distributed computing environments, the program module can be located in both local and remote computer storage media including storage devices.

The embodiments of this application are described in a progressive manner. For same or similar parts in the embodiments, references can be made to each other. Each embodiment focuses on a difference from another embodiment. Particularly, the system embodiments are basically similar to the method embodiments, and therefore are described briefly. For related parts, references can be made to some descriptions in the method embodiments. In the descriptions of this application, descriptions provided with reference to terms such as “an embodiment”, “some embodiments”, “an example”, “a specific example”, or “some examples” intend to mean that a specific feature, structure, material, or characteristic described with reference to the embodiment or example is included in at least one embodiment or example of the embodiments of this application. In this application, illustrative expressions of these terms do not necessarily refer to the same embodiment or example. Moreover, the specific features, structures, materials, or characteristics described may be combined in any one or more embodiments or examples in a suitable manner. In addition, a person skilled in the art can combine and associate different embodiments or examples and features of different embodiments or examples described in this application, provided that the embodiments or examples and the features do not conflict with each other.

The above-mentioned descriptions are one or more embodiments of this application, and are not intended to limit the one or more embodiments of this application. A person skilled in the art can make various changes and variations to one or more embodiments of this application. Any modification, equivalent replacement, or improvement made without departing from the spirit and principle of this application shall fall within the scope of the claims.

What is claimed is:

1. A computer-implemented method for blockchain system transaction proposal applied to any target consensus node that has blockchain system transaction proposal permission, comprising:
calculating a digest value of a transaction maintained in a local transaction pool, wherein a blockchain system comprises a plurality of consensus nodes that have transaction proposal permission, wherein local transaction pools of the consensus nodes that have transaction proposal permission in the blockchain system comprise duplicate transactions;
performing an arithmetic operation on the digest value and a predetermined value;
determining, based on an operation result of the arithmetic operation, whether a target consensus node has transaction proposal permission for the transaction; and
if the target consensus node has transaction proposal permission for the transaction, adding the transaction to a pending-consensus transaction set proposed by the target consensus node for a pending-consensus target block.

2. The computer-implemented method of claim 1, wherein the calculating a digest value of a transaction maintained in a local transaction pool comprises:
performing data concatenation on transaction content of the transaction maintained in the local transaction pool and a block identifier of the pending-consensus target block; and
calculating, as the digest value of the transaction, a digest value of data content obtained through the data concatenation.

3. The computer-implemented method of claim 1, wherein:
the predetermined value is a target quantity value that corresponds to a total quantity of the consensus nodes in the blockchain system; and
the performing an arithmetic operation on the digest value and a predetermined value comprises:
performing the arithmetic operation on the digest value and the target quantity value.

4. The computer-implemented method of claim 3, wherein:
a node identifier of each consensus node in the blockchain system is an unsigned integer not greater than the target quantity value; and
the performing an arithmetic operation on the digest value and the target quantity value, comprises:
performing a mod operation on the digest value and the target quantity value, so that a value that corresponds to an operation result of the arithmetic operation is less than the target quantity value.

5. The computer-implemented method of claim 3, wherein the determining, based on an operation result of the arithmetic operation, whether the target consensus node has transaction proposal permission for the transaction, comprises:
matching the operation result of the arithmetic operation with a node identifier of the target consensus node, and determining, based on a matching result, whether the target consensus node has transaction proposal permission for the transaction.

6. The computer-implemented method of claim 5, wherein:
the operation result of the arithmetic operation and the node identifier of each consensus node in the blockchain system are each an unsigned integer less than the target quantity value; and
the matching the operation result of the arithmetic operation with a node identifier of the target consensus node, and determining, based on a matching result, whether the target consensus node has transaction proposal permission for the transaction, comprises:
performing value matching on a first value that corresponds to the operation result of the arithmetic operation and a second value that corresponds to the node identifier of the target consensus node; and
if the first value and the second value are identical, determining that the target consensus node has transaction proposal permission for the transaction.

7. The computer-implemented method of claim 5, wherein:
the node identifier of each consensus node in the blockchain system is an unsigned integer less than the target quantity value, and the operation result of the arithmetic operation is an unsigned integer not less than the target quantity value; and
the matching the operation result of the arithmetic operation with a node identifier of the target consensus node, and determining, based on a matching result, whether the target consensus node has transaction proposal permission for the transaction, comprises:
matching a third value that corresponds to the operation result of the arithmetic operation with a value range bound to the node identifier of the target consensus node, wherein the value range is used to determine a transaction proposed by the target consensus node; and
if the third value hits the value range, determining that the target consensus node has transaction proposal permission for the transaction.

8. The computer-implemented method of claim 3, comprising:
determining whether a quantity of transactions in the transaction set reaches a predetermined threshold; and
if the quantity of transactions in the transaction set reaches the predetermined threshold, transmitting the transaction set to other consensus nodes, to initiate consensus processing on the transaction set.

9. The computer-implemented method of claim 6, comprising:
receiving a pending-consensus transaction set proposed by another consensus node for the pending-consensus target block;
calculating a digest value of a transaction in the transaction set, and performing the arithmetic operation on the digest value and the target quantity value;
matching an operation result obtained through the arithmetic operation against the node identifier of the target consensus node, and determining, based on a matching result, whether the another consensus node is a malicious node; and
if the another consensus node is a malicious node, storing the another consensus node as a malicious node; or if the another consensus node is not a malicious node, perform consensus processing on the transaction set.

10. The computer-implemented method of claim 9, wherein the calculating a digest value of a transaction in the transaction set, comprises:
performing data concatenation on transaction content of the transaction in the transaction set and a block identifier of the pending-consensus target block, and calculating, as the digest value of the transaction, a digest value of data content obtained through the data concatenation.

11. The computer-implemented method of claim 9, wherein:
if the operation result of the arithmetic operation and the node identifier of each consensus node in the blockchain system are each an unsigned integer less than the target quantity value:
matching the operation result of the arithmetic operation with a node identifier of the another consensus node, and determining, based on a matching result, whether the another consensus node is a malicious node, comprises:
performing value matching on a fourth value that corresponds to the operation result of the arithmetic operation and a fifth value that corresponds to the node identifier of the another consensus node.

12. The computer-implemented method of claim 11, wherein:
matching the operation result of the arithmetic operation with a node identifier of the another consensus node, and determining, based on a matching result, whether the another consensus node is a malicious node, comprises:
if the fourth value and the fifth value are identical, determining that the another consensus node is not a malicious node; or determining that the another consensus node is a malicious node.

13. The computer-implemented method of claim 9, wherein:
if the node identifier of each consensus node in the blockchain system is an unsigned integer less than the target quantity value, but the operation result of the arithmetic operation is an unsigned integer not less than the target quantity value:
matching the operation result of the arithmetic operation with a node identifier of the another consensus node, and determining, based on a matching result, whether the another consensus node is a malicious node, comprises:
matching a sixth value that corresponds to the operation result of the arithmetic operation with a value range bound to a node identifier of the another consensus node.

14. The computer-implemented method of claim 13, wherein:
matching the operation result of the arithmetic operation with a node identifier of the another consensus node, and determining, based on a matching result, whether the another consensus node is a malicious node, comprises:
if the sixth value hits the value range, determining that the another consensus node is not a malicious node; or determining that the another consensus node is a malicious node.

15. The computer-implemented method of claim 9, comprising:
determining whether a pending-consensus transaction set proposed by the malicious node for the pending-consensus target block is received.

16. The computer-implemented method of claim 15, comprising:
if the pending-consensus transaction set proposed by the malicious node for the pending-consensus target block is received, skipping performing consensus voting on the transaction set; or voting against approving the transaction set during a consensus voting phase.

17. The computer-implemented method of claim 1, comprising:
removing transactions in the transaction set from the local transaction pool in response to a success of consensus processing on the transaction set.

18. The computer-implemented method of claim 1, wherein the blockchain system is a blockchain system that uses a HoneyBadgerBFT protocol.

19. A non-transitory, computer-readable medium storing one or more instructions executable by a computer system to perform one or more operations for blockchain system transaction proposal applied to any target consensus node that has blockchain system transaction proposal permission, comprising:
calculating a digest value of a transaction maintained in a local transaction pool, wherein a blockchain system comprises a plurality of consensus nodes that have transaction proposal permission, wherein local transaction pools of the consensus nodes that have transaction proposal permission in the blockchain system comprise duplicate transactions;
performing an arithmetic operation on the digest value and a predetermined value;
determining, based on an operation result of the arithmetic operation, whether a target consensus node has transaction proposal permission for the transaction; and
if the target consensus node has transaction proposal permission for the transaction, adding the transaction to a pending-consensus transaction set proposed by the target consensus node for a pending-consensus target block.

20. A computer-implemented system for blockchain system transaction proposal applied to any target consensus node that has blockchain system transaction proposal permission, comprising:
one or more computers; and
one or more computer memory devices interoperably coupled with the one or more computers and having tangible, non-transitory, machine-readable media storing one or more instructions that, when executed by the one or more computers, perform one or more operations, comprising:
calculating a digest value of a transaction maintained in a local transaction pool, wherein a blockchain system comprises a plurality of consensus nodes that have transaction proposal permission, wherein local transaction pools of the consensus nodes that have transaction proposal permission in the blockchain system comprise duplicate transactions;
performing an arithmetic operation on the digest value and a predetermined value;
determining, based on an operation result of the arithmetic operation, whether a target consensus node has transaction proposal permission for the transaction; and
if the target consensus node has transaction proposal permission for the transaction, adding the transaction to a pending-consensus transaction set proposed by the target consensus node for a pending-consensus target block.
